(19) United States
(12) Patent Application Publication
(10) Pub. No.: US 2005/0138222 A1
(43) Pub. Date: Jun. 23, 2005

(54) Integrated visual and language-based system and method for reusable data transformations

(75) Inventors: Srinivas Chari, Toronto (CA); Crystal Su, Toronto (CA); Milorad Stefanovic, Markham (CA); Dirk Alexander Seelemann II, Thornhill (CA)

Correspondence Address: Diana L. Roberts;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/753,856

(22) Filed: Jan. 8, 2004

(30) Foreign Application Priority Data
Dec. 17, 2003 (CA) 10/753856

(51) Int. Cl. G06F 3/00

(52) U.S. Cl. 710/1; 707/101

(57) ABSTRACT

There is provided a method and system for developing a transformation program to transform a data structure from a first format to a second format, the program including a plurality of coupled data transformation modules describing the transformation, the method comprising the steps of: generating a first transformation module of the plurality of transformation modules for assembling the program, the first module being a module type of a set of module types including a language constructed module type and a visually constructed module type; extracting reference information from the first module for accessing the first module when stored in a memory; and updating a module registry to include a first entry corresponding to the reference information of the first module, the module registry configured for having reference information entries extracted from both the language constructed modules and visually constructed modules.

### FIELD OF THE INVENTION

The present invention relates to programming environments in general, and more specifically to a programming environment for supporting the coexistence of a visual transform method and a language transform method.

### BACKGROUND OF THE INVENTION

Development of transformation applications involves multiple players and roles. On one hand, high level transformation scenarios are typically designed by business analysts. On the other hand, application implementation, with technical requirements such as performance, is typically handled by highly specialized application programmers or developers. These two types of players have diverse backgrounds, different perspectives of the problem domain, and often times very different programming skills. Their responsibilities are different, but they also must communicate with each other and work together to produce an efficient, scalable and maintainable transformation system.

An environment based exclusively on visual transformation methods can provide all benefits associated with visual programming, such as ease of use. Transformation modules developed in this way can take advantage of some existing language-based artifacts under specific conditions. However, language based artifacts cannot take advantage of the visually developed artifacts. There is no round trip since visual tools produce proprietary formatted artifacts that are not accessible to programming languages in the public domain.

When a transformation system is developed using visual tools, it is usually easier to prototype, but it is not optimal when the transformation load increases due to the inherent properties of visual programming. Visual programming targets fairly coarse grained transformations. On the other hand, language-based transformations scale very well from a performance point since optimizations can be used at a very fine grain. However, it is harder to maintain as the complexity of the tool increases, and even experienced developers will need more time to ensure system integrity, since the effects of the change are harder to predict. There is a trade-off between these two factors when we consider the two approaches in transformation of the data structures.

These input data structures represent different kinds of information stored in various storage and transmission formats, which describe the domain in which the transformation operates. For instance, the transformation domain for SQL (Structured Query Language) is Relational Database (RDB) tables and columns. The domain for the EJB (Enterprise Java Beans) mapping tool in IBM WebSphere® Studio Advanced Developer includes EJB fields and RDB tables and columns. The transformation domain for TIBCO Software's mapping tool, BEA System's eLink™ family of tools, and IBM WebSphere MQ Integrator includes messages and RDB tables and columns.

Traditionally, there have been two different approaches to perform data transformation. These approaches have proven to be mutually exclusive in usage. The different approaches include either visual based tools or language based tools. Language based tools were used to perform data transformations since a programming languages can be exploited to achieve highly complex and efficient transformations. It was observed over a period of time that a significant proportion of such data transformations are straightforward assignment mappings from one field to the other. This led to the development of visual tools to make this process simpler and quicker to achieve for the most part. However, some complex scenarios are difficult or not possible to achieve using these visual tools alone. This is because a visual tool is designed for ease of use and higher level analysis, not for greatest optimization. Therefore, some of the optimizations that are possible using language based transformation modules are not feasible when using a graphical engine to generate the transformation modules used to perform the transformations of the data structures. There are proponents for each approach leading to solutions that used one approach or the other.

### SUMMARY OF THE INVENTION

According to the present invention there is provided a method for developing a transformation program to transform a data structure from a first format to a second format, the program including a plurality of coupled data transformation modules describing the transformation, the method comprising the steps of: generating a first transformation module of the plurality of transformation modules for assembling the program, the first module being a module type of a set of module types including a language constructed module type and a visually constructed module type; extracting reference information from the first module for accessing the first module when stored in a memory; and updating a module registry to include a first entry corresponding to the reference information of the first module, the module registry configured for having reference information entries extracted from both the language constructed modules and visually constructed modules.

According to a further aspect of the present invention there is provided a system for developing a transformation program to transform a data structure from a first format to a second format, the program including a plurality of coupled data transformation modules describing the transformation, the system comprising: an editor for generating a first transformation module of the plurality of transformation modules to assemble the program, the first module being a module type of a set of module types including a language constructed module type and a visually constructed module type; a reference module for extracting reference information from the first module for accessing the first module when stored in a memory; and a module registry for including a first entry corresponding to the reference information of the first module, the module registry configured for having reference information entries extracted from both the language constructed modules and visually constructed modules.

According to a still further aspect of the present invention there is provided a computer program product for developing a transformation program in a programming environment to transform a data structure from a first format to a second format, the program including a plurality of coupled data transformation modules describing the transformation, the computer program product comprising: a computer readable medium; an editor module stored on the medium for generating a first transformation module of the plurality of transformation modules to assemble the program, the first module being a module type of a set of module types including a language constructed module type and a visually constructed module type; a reference module coupled to the editor module for extracting reference information from the first module for accessing the first module when stored in a memory; and a registry module coupled to the reference module for including a first entry corresponding to the reference information of the first module, the registry module configured for having reference information entries extracted from both the language constructed modules and visually constructed modules.

According to a further aspect of the present invention there is provided a computer readable medium containing computer executable code for, in a programming environment, developing a transformation program to transform a data structure from a first format to a second format, the program including a plurality of coupled data transformation modules describing the transformation, the code comprising code for generating a first transformation module of the plurality of transformation modules for assembling the program, the first module being a module type of a set of module types including a language constructed module type and a visually constructed module type; extracting reference information from the first module for accessing the first module when stored in a memory; and updating a module registry to include a first entry corresponding to the reference information of the first module, the module registry configured for having reference information entries extracted from both the language constructed modules and visually constructed modules.

### BRIEF DESCRIPTION OF THE DRAWINGS

A better understanding of these and other embodiments of the present invention can be obtained with reference to the following drawings and detailed description of the preferred embodiments, in which:

FIG. 1 shows a data transformation system;

FIG. 2 shows integrated referencing of transformation modules of FIG. 1;

FIG. 3 shows the integrated, seamless reuse of visual and language-based modules of the system of FIG. 2;

FIG. 4 is a language-based transformation module (ESQL routines) of the system of FIG. 1;

FIG. 5 is a visually constructed transformation module (mapping routine) of the system of FIG. 1; and

FIG. 6 is a visually constructed routine calls language-based routine.

It is noted that similar references are used in different figures to denote similar components.

### DETAILED DESCRIPTION OF THE EMBODIMENT

The following detailed description of the embodiments of the present invention does not limit the implementation of the invention to any particular computer programming language. The present invention may be implemented in any computer programming language provided that the OS (Operating System) provides the facilities that may support the requirements of the present invention. A preferred embodiment is implemented in the C or C++ computer programming language or Java (or other computer programming languages in conjunction with C/C++). Any limitations presented would be a result of a particular type of operating system, computer programming language, or data processing system and would not be a limitation of the present invention.

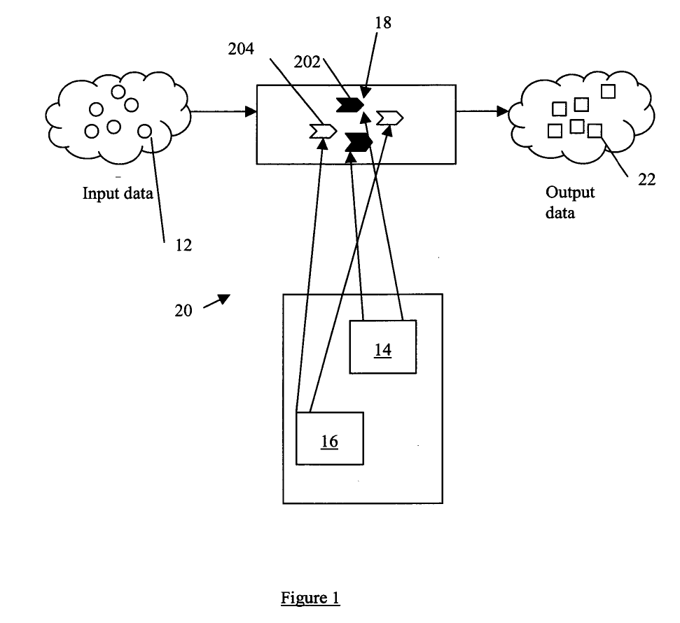

Generally, data transformation is a process of modifying and processing data content from an input data structure to obtain and/or transmit useful information in a different format or output data structure. A software transformation artifact or module is a reusable component such as a program unit used as a procedure or more importantly, a data transformation, such that one of more transformation modules can be combined to effect a data transformation of a data structure. FIG. 1 shows how a set of circular input data structures 12 can be transformed into square output data structures 22. The solid black chevrons represent a visually based transformation module 202, and the white chevrons represent other language based transformation modules 204.

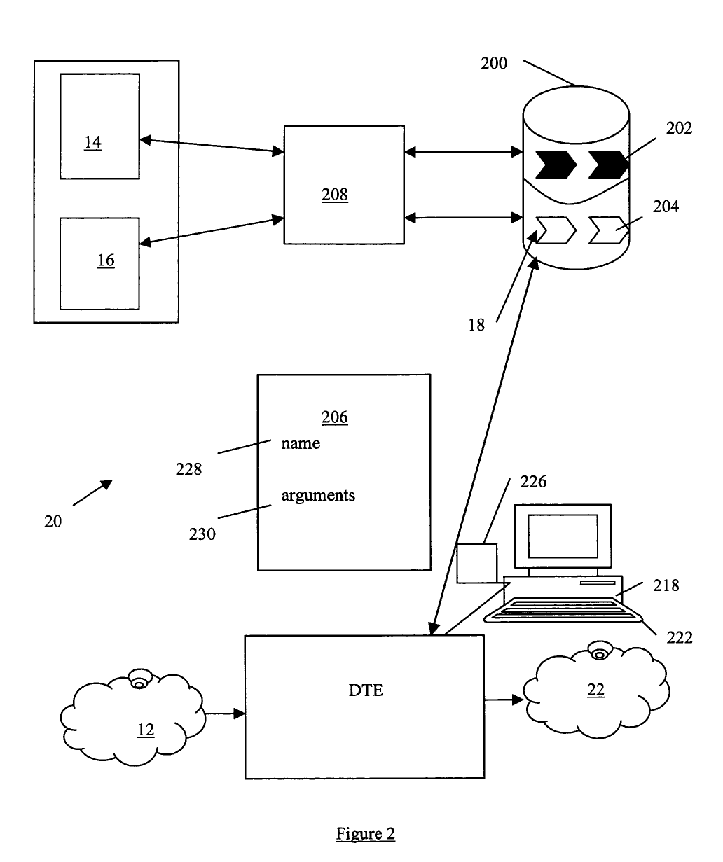

Referring to FIG. 1, there are two programming methods to describe transformations of the data structures 12: a visual editor 14 and a language-based editor 16. Both editors 14,16 are used to construct executable transformation modules 18 (which can correspond to routines) that are used to direct a data processing system 20 to transform the input data structures 12 of a first data format to the transformed data structure 22 of a second data format different from the first data format. Both transformation methods of the editors 14,16 are combined and coexist in one programming environment provided by the system 20, (a combination of a data processing system 20 having a processor 218 and memory 200 for storing an operating system for directing the processor 218—see FIG. 2) since each of these transformation processes can offer advantages in performing some specific programming tasks.

Referring again to FIG. 2, the system 20 also has a user interface 222, coupled to the processor 218, to interact with a user (not shown) to deploy the data transformation represented by the modules 18. The user interface 222 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the processor 218. The user interface 222 is employed by the user of the system 20 to coordinate a Data Transformation Engine (DTE) of the system 20 to implement the data transformation described by a set of the modules 18 in the memory 200. The DTE takes as input one or more modules 18 from storage 200, and data 12 in a Source format (or a pointer to where the data is stored). The DTE will output data 22 in a Target format as described by the modules 18 used in the transformation process. The DTE uses the user interface 222 so that the user can specify what data 12 is to be transformed, and by which modules 18, including both the modules 202 and 204.

Further, it is recognized that the system 20 can include a computer readable storage medium 224 coupled to the processor 218 for providing instructions to the processor 218 and/or to load/update the modules 202,204 in the memory 200. The computer readable medium 226 can include hardware and/or software such as, by way of example only, magnetic disks, magnetic tape, optically readable medium such as CD/DVD ROMS, and memory cards. In each case, the computer readable medium 226 may take the form of a small disk, floppy diskette, cassette, hard disk drive, solid state memory card, or RAM provided in the memory 200. It should be noted that the above listed example computer readable mediums 226 can be used either alone or in combination. It is also recognized that the editors 14,16 can have individual interfaces, processors, and mediums 226 as described above in order to configure the editors 14,16 to access modules 18 resident in the storage 200 through a symbol table 206. Further, the mediums 226 could be used to program the editor 14,16 to interact or otherwise emulate the functionality of an referencing module or extractor 208 in conjunction with the table 206.

Referring to FIGS. 1 and 2, the transformation modules 18 created by both of these transformation editors 14,16 are stored in files in the memory 200 of the data processing system 20. There can be one or more data transformation modules 18 in memory 200. The solid black chevrons represent the visually generated transformation modules 202, and the white chevrons represent the language-based modules 204. Each type of module 202,204 is stored in different containers in a file system (usually in files) of the memory 200, and each file may contain several such reusable modules 202,204. Once the modules 202,204 are loaded into the working memory of the computer processor 218, the modules 202, 204 have access to each other through references in the transformation module registry 206 (such as but not limited to a symbol table).

Referring again to FIG. 2, the language based editor 16 comprises a user interface, and the other functionality required to create the transformation modules 204. When the module 204 is created,
1. the module 204 is sent to the appropriate file in storage 200, and
2. the extractor module 208 parses certain fields from the module 204 (e.g. the artifact's name, parameters or input taken, and output or data type returned) so that the symbol table 206 can be updated.

The visually based editor 14 comprises a graphic user interface, and the other functionality required to create the transformation modules 202. The editor 14 also includes a visual interface to the symbol table 206, so that the user can incorporate existing modules 18 of either type (i.e. 202 and 204). When the module 202 is created, it is sent to the storage 200, and also passed through the extractor 208 so that the symbol table 206 can be updated. The symbol table 206 uses a common model to store the particulars of both types of modules 202, 204 created using either editor 14,16. Accordingly, the modules 202, 204 can reference other modules 202, 204 of either type through the symbol table 206. Further, it is recognised that an existing module 18 can also be modified for re-use, in regard to backwards-compatibility of existing libraries of transformation modules (not shown). For example, existing modules 202, 204 could be incorporated into the system 20 by firstly running them through the extractor 208 to update the symbol table 206 with references to the now updated modules 202, 204, and secondly storing each updated module 18 in the appropriate file in the storage 200. This would facilitate old modules 18 to later be used or modified using the integrated system 20.

The editors 14,16 use the extractor 208 to populate the table 206 using selected information about the modules 18 created, edited, and/or otherwise accessed by the editors 14,16 The table 206 contains certain identification information 228 and content information 230 of both the visual 202 and language 204 based modules contained in the memory 200. For example, the ID information 228 could include such as but not limited to the “name” of the modules 18. The content information 230 can include such as but not limited to a list of arguments and argument types used by the modules 18, as well as a descriptive summary of the functionality of each of the modules 18. Accordingly, the extractor 208 updates the table 206 with reference information 228,230 for both module 202,204 types accessible through the memory 200.

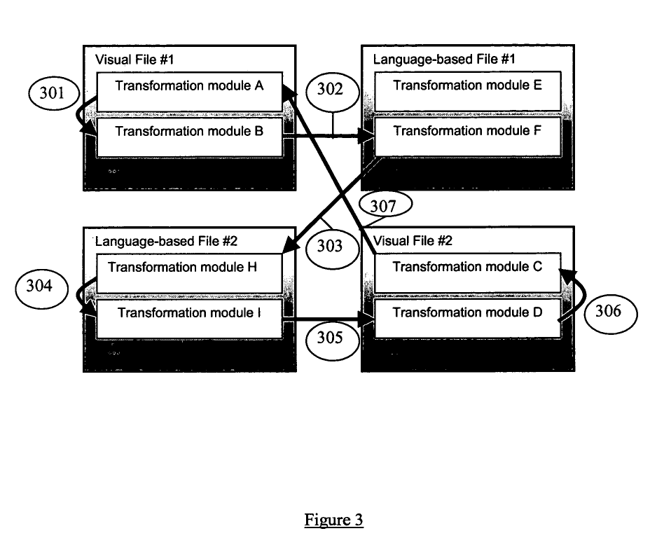

FIG. 3 shows how to reuse visual and language-based modules seamlessly to assemble the transformation program. Whether the transformation modules 18 are constructed using the visual editor 14 or the language-based editor 16, whatever transformation editor is used should be completely transparent to the programming environment and to the programmer for ease of use.

Regardless of the method used for their construction, the data transformation modules 18 can be called from other modules 18. All module calls shown in the example from FIG. 3 are legal (in the sense of proper use in a data processing environment), in that:
call 301—visually constructed transformation module (a) to another visually constructed transformation module (b) within the same file;
call 302—visually constructed transformation module (b) to a language-based transformation module (f) in a different file;
call 303—language-based transformation module (f) to another language-based transformation module (h) in a different file;
call 304—language-based transformation module (h) to another language-based transformation module (i) within the same file;
call 305—language-based transformation (i) module to a visually constructed transformation module (d) in a different file;
call 306—visually constructed transformation module (d) to another visually constructed transformation module (c) within the same file; and,
call 307—visually constructed transformation module (c) to another visually constructed transformation module (a) in a different file.

It is recognized that the modules (a)-(i) are stored in memory 200 and each has reference information stored in the table 206, such that the reference information facilitates the coupling between the various modules (a)-(i).

The language used in this specific application domain of the system 10 can be for example, ESQL (Expanded Structured Query Language), a procedural language based on the SQL standard. The components of the data transformation module 18 correspond to ESQL routines (that is, functions and procedures).

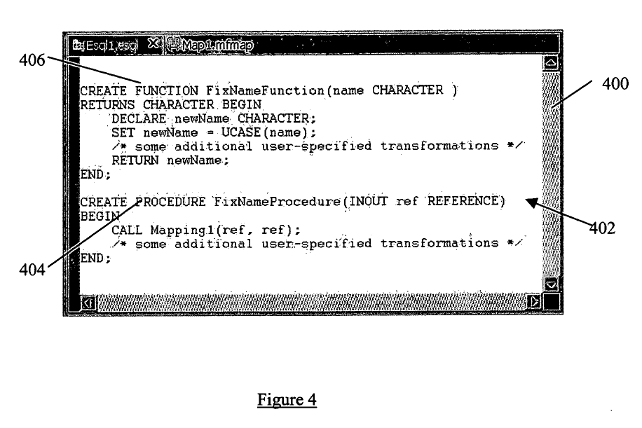

FIG. 4 shows a language-based transformation modules 400 (ESQL routines). We see sample source code 402 showing how two different routines are written: a procedure 404 and a function 406. Observe that the function 406 FixNameFunction calls a reusable routine called Mapping procedure 404, which is generated using the visual editor 14.

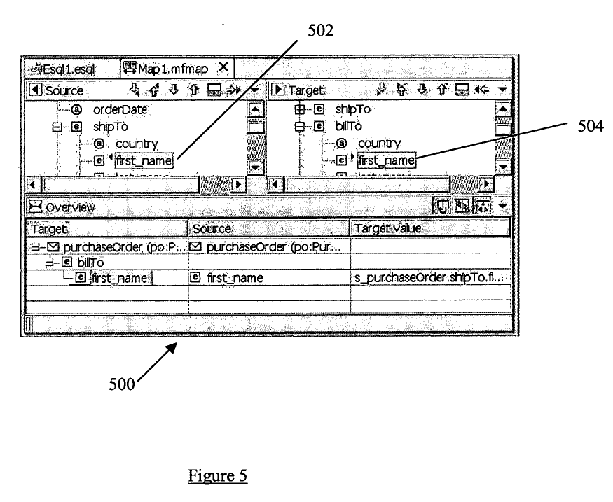

FIG. 5 shows a visually constructed transformation module 500 (mapping routine). Here, we show how a direct assignment occurs between two data structures 12 that are modeled graphically as trees. We may wish to assign the value of the input field first_name 502 in the ship_to data structure to the fieldfirst_name 504 in the bill_to data structure, or to perform some operation on this field's input before the actual assignment.

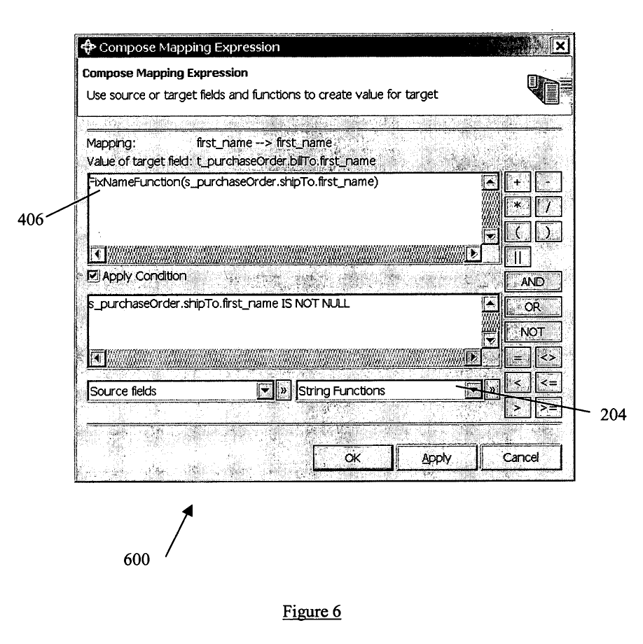

FIG. 6 shows visually constructed routine calls language-based routine 600. We now consider the case where the task is not a simple assignment but we need to perform some additional work. In this case, we can reuse a language based module 400 from the visual module 600 using a composer dialog. This dialog allows the user to develop a complex transformation that reuses the function 406 called FixNameFunction that is developed using the language based editor 16. Observe that in the dialog, there can be additional tools that allow the user to reuse function libraries of pre-existing language based modules 204 such as string library functions.

The above examples show a very simple but effective case where the visual module 600 reuses a language based module 400, and where a language based module 400 reuses a visually generated module 500.

It will be appreciated that variations of some elements are possible to adapt the invention for specific conditions or functions. The concepts of the present invention can be further extended to a variety of other applications that are clearly within the scope of this invention. Having thus described the present invention with respect to preferred embodiments as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

1. In a programming environment, a method for developing a transformation program to transform a data structure from a first format to a second format, the program including a plurality of coupled data transformation modules describing the transformation, the method comprising the steps of:
generating a first transformation module of the plurality of transformation modules for assembling the program, the first module being a module type of a set of module types including a language constructed module type and a visually constructed module type;
extracting reference information from the first module for accessing the first module when stored in a memory; and
updating a module registry to include a first entry corresponding to the reference information of the first module, the module registry configured for having reference information entries extracted from both the language constructed modules and visually constructed modules.

2. The method of claim 1 further comprising the step of storing the first module in the memory.

3. The method of claim 2 further comprising the step of generating a second transformation module coupled to the first module using the first entry of the module registry.

4. The method of claim 3 further comprising the step of updating the module registry to include a second entry corresponding to reference information of the second module;

5. The method of claim 4, wherein the second module is of the module type different from the first module.

6. The method of claim 5, wherein the first module is the language constructed module type and the second module is the visually constructed module type.

7. The method of claim 1, wherein the module registry is a symbol table.

8. The method of claim 7 further comprising the step of including identification information in the reference information, the identification information including a name of the first reference module.

9. The method of claim 8 further comprising the step of including content information in the reference information.

10. The method of claim 9, wherein the content information is selected from the group comprising; an argument, an argument type, and a descriptive summary of functionality of the first module.

11. The method of claim 1, wherein the first module includes a call selected from the group comprising a procedure and a function.

12. The method of claim 2 further comprising the step of storing the first module in the memory in a file, the file configured for having at least two of the plurality of coupled transformation modules, the two modules being of the same module type.

13. In a programming environment, a system for developing a transformation program to transform a data structure from a first format to a second format, the program including a plurality of coupled data transformation modules describing the transformation, the system comprising:
an editor for generating a first transformation module of the plurality of transformation modules to assemble the program, the first module being a module type of a set of module types including a language constructed module type and a visually constructed module type;
a reference module for extracting reference information from the first module for accessing the first module when stored in a memory; and
a module registry for including a first entry corresponding to the reference information of the first module, the module registry configured for having reference information entries extracted from both the language constructed modules and visually constructed modules.

14. The system of claim 13, wherein the first module is stored in the memory.

15. The system of claim 14 further comprising a second transformation module coupled to the first module using the first entry of the module registry.

16. The system of claim 15, wherein the module registry includes a second entry corresponding to reference information of the second module;

17. The system of claim 16, wherein the second module is of the module type different from the first module.

18. The system of claim 17, wherein the first module is the language constructed module type and the second module is the visually constructed module type.

19. The system of claim 13, wherein the module registry is a symbol table.

20. The method of claim 19 further comprising the reference information configured to include identification information, the identification information having a name of the first reference module.

21. The system of claim 20 further comprising the reference information configured to include content information.

22. The system of claim 21, wherein the content information is selected from the group comprising; an argument, an argument type, and a descriptive summary of functionality of the first module.

23. The system of claim 13, wherein the first module includes a call selected from the group comprising a procedure and a function.

24. The system of claim 14 further comprising a file system in the memory for storing the first module in a file, the file configured for having at least two of the plurality of coupled transformation modules, the two modules being of the same module type.

25. A computer program product for developing a transformation program in a programming environment to transform a data structure from a first format to a second format, the program including a plurality of coupled data transformation modules describing the transformation, the computer program product comprising:
a computer readable medium;
an editor module stored on the medium for generating a first transformation module of the plurality of transformation modules to assemble the program, the first module being a module type of a set of module types including a language constructed module type and a visually constructed module type;
a reference module coupled to the editor module for extracting reference information from the first module for accessing the first module when stored in a memory; and
a registry module coupled to the reference module for including a first entry corresponding to the reference information of the first module, the registry module configured for having reference information entries extracted from both the language constructed modules and visually constructed modules.

26. A computer readable medium containing computer executable code for, in a programming environment, developing a transformation program to transform a data structure from a first format to a second format, the program including a plurality of coupled data transformation modules describing the transformation, the code comprising code for:
generating a first transformation module of the plurality of transformation modules for assembling the program, the first module being a module type of a set of module types including a language constructed module type and a visually constructed module type;
extracting reference information from the first module for accessing the first module when stored in a memory; and
updating a module registry to include a first entry corresponding to the reference information of the first module, the module registry configured for having reference information entries extracted from both the language constructed modules and visually constructed modules.
